(19) United States
(12) Patent Application Publication
(10) Pub. No.: US 2024/0184974 A1
(43) Pub. Date: Jun. 6, 2024

(54) ARTIFICIAL INTELLIGENCE-BASED SYSTEMS AND METHODS FOR TEXTUAL IDENTIFICATION AND FEATURE GENERATION

(71) Applicant: Temple University - Of The Commonwealth System of Higher Education, Philadelphia, PA (US)

(72) Inventors: Scott C. Burris, Narberth, PA (US); Heidi Grunwald, Lafayette Hill, PA (US)

(21) Appl. No.: 18/526,556

(22) Filed: Dec. 1, 2023

Related U.S. Application Data
(60) Provisional application No. 63/385,876, filed on Dec. 2, 2022.

(51) Int. Cl. G06F 40/12; G06Q 50/18

(52) U.S. Cl. CPC G06F 40/12; G06Q 50/18

(57) ABSTRACT

An artificial intelligence (AI)-based method for textual identification and feature generation. The method includes: defining a scope including type, time, and geographic dimensions of texts to be analyzed; collecting, identifying, and coding using a coding protocol selected features of the texts using a pre-defined research procedure and feature set; creating a corpus of machine-readable data and metadata in a software database that includes a scraping tool for searching the worldwide web for text instances and a corpus of text types; interfacing with the software to train an AI assist tool and validate its results; and using the AI assist tool to identify the particular text type and apply the coding protocol to create new and update existing data and metadata. Also provided are a related system and at least one computer-readable non-transitory storage media embodying software.

### CROSS-REFERENCE TO RELATED APPLICATIONS

This application claims priority to U.S. Provisional Patent Application No. 63/385,876, filed on Dec. 2, 2022, incorporated herein by reference in its entirety.

### TECHNICAL FIELD

The present disclosure relates generally to textual identification and feature generation and, more particularly, to artificial intelligence-based or artificial intelligence-assisted systems and methods for the systematic collection of relevant texts, creation of machine-readable data, analysis, and dissemination of laws and policies across jurisdictions or institutions, and over time.

### BACKGROUND OF THE DISCLOSURE

Technology has transformed how human beings live, providing new opportunities for learning and performing complex tasks. The ubiquitous availability of increasing computing capacity have made it possible for intelligent machines to be used in our daily lives. Artificial intelligence or “AI” is becoming more and more common.

AI is defined as the theory and development of computer systems able to perform tasks that normally require human intelligence, such as visual perception, speech recognition, decision-making, and translation between languages. Computer scientists sometimes call AI “machine intelligence” to distinguish intelligence demonstrated by machines from the natural intelligence displayed by human beings. Leading AI textbooks define the field as the study of intelligent agents: any device that perceives its environment and takes actions that maximize its chance of successfully achieving its goals. Colloquially, the term AI is often used to describe machines (or computers) able to mimic cognitive functions that human beings associate with the human mind, such as learning and problem solving. Although lacking a uniformly accepted and clear definition, AI generally involves four steps: collect data, run the data through an analytical model to predict, optimize the model and make decisions, then have the system adapt or learn.

In the past decade, as a result of expanding data availability, improvements in hardware, and novel machine learning (ML) algorithms, AI has shown great promise across a wide array of applications, ranging from digital advertising to self-driving cars to electronic trading platforms. For example, EV manufacturers use human training to help the AI in their self-driving car systems learn to generate road features. (see W. Knight, Wired, Sep. 7, 2021).

Systems that imitate human intelligence are also integral to textual identification and feature generation. Fundamental to the incorporation of AI in textual identification and feature generation is ML, which uses algorithms to find patterns in massive amounts of data that could include numbers, words, sounds, and images. Compared to technologies that aim to mimic the human decision process, modern AI technologies are data-driven in that they analyze large volumes of complex data in novel ways; discover new relationships between the information entered and the desired results from the available data; and can adapt their reasoning based on new data.

In recent years, there has been an increased use of AI/ML in the legal field, especially for tasks that require the analysis of large volumes of data or the interpretation of complex information (see S. Burris, I/S: A Journal of Law & Policy for the Information Society, 2015). Innovative solutions employing AI/ML in the legal field have the potential to optimize and improve the delivery of information to researchers, practitioners, advocates and policymakers. Adaptive AI/ML technologies have the potential to optimize the performance of analytical tools in real-time to continuously improve legal research and practice.

Taiwan Patent No. 202001781 (Wei Ling Lin) titled “Big Data Analysis, Prediction, And Data Visualization System For Legal Documents” acknowledges that legal language is difficult for the general public to understand which makes widespread education unrealistic. It is also impossible for the general public to use limited keywords to do legal research. When legal disputes occur, the judges and attorneys must search the database of legal judgments to understand the relevant law; they use keywords that require professional skills and experience. Human beings cannot read a large number of judgments, however, within a limited period of time. Therefore, disclosed herein is a big data analysis, prediction, and graph display system for legal documents. AI is used to search and study a large number of laws, regulations, orders, and one or more databases comprising a plurality of judgments. When general public users input information, the disclosed system statistically analyzes all relevant laws, regulations, and related judgments. The system shows the result in a simple image table. This system is not intended to replace the work of the legal profession, but to help the general public to know more about the laws, regulations, and legal practice in, for example, a foreign jurisdiction such as Taiwan or Mainland China. The general public can save time and money through predicting possible litigation directions and results. People can decide whether to initiate litigation more easily. The system can be used by law firms, courts, or ordinary citizens. Visualization of legal data makes laws easy to understand and accelerates the proliferation of legal knowledge. Some embodiments of the disclosed system also provide the corresponding application platform for mobile devices.

U.S. Patent Application Publication No. 2018/0189797, titled “Validating Compliance Of An Information Technology Asset Of An Organization To A Regulatory Guideline” discloses a system and method for validating compliance of an information technology (IT) asset of an organization to a regulatory guideline. The method comprises accessing raw data from a plurality of data sources, wherein the raw data comprises at least one of an operation data, an IT asset data, a regulatory intelligence data, and a regulatory reference data; processing the raw data to extract one or more regulatory parameters; analyzing the one or more regulatory parameters using one or more AI computing processes to assess at least one of a regulatory risk and a corresponding regulatory impact; and validating the compliance of the IT asset to the regulatory guideline based on at least one of the regulatory risk and the corresponding regulatory impact.

Neural networks, a commonly used form of AI/ML, are a technology that has been available since the 1960s and has been well-established in legal research for several decades. Neural networks typically include at least three layers of neurons: (1) an input layer that receives information, (2) a hidden layer that is responsible for extracting patterns and conducting the internal processing (the hidden layer performs the mathematical translation tasks that turn raw input into meaningful output), and (3) an output layer that produces and presents the final network output. Neural networks are loosely based on the way biological neurons connect with one another to process signals and information in the brains of animals. Similar to the way electrical signals travel across the cells of living creatures, each subsequent layer of nodes is activated when it receives stimulus from its neighboring neurons.

A complex form of artificial neural networks is deep learning which has many layers of computational nodes or neural networks that work together to process data and deliver a final result. In summary, deep learning is a type of neural network which is a type of ML which, in turn, is a type of AI. In deep learning, each layer may be assigned a specific portion of a transformation task and data might traverse the layers multiple times to refine and optimize the ultimate output. This type of AI is scalable (i.e., it can process large data sets using large models that can expand) and is hierarchical (i.e., it performs automatic feature extraction from raw data called feature learning), building more complicated concepts from simpler ones. Deep learning allows the system to recognize patterns independently and make predictions.

Deep learning is a branch of AI that has quickly become transformative for legal research, offering the ability to analyze data with a speed and precision never seen before. Deep learning uses a layered algorithmic architecture to analyze data. In deep learning models, data are filtered through a cascade of multiple layers, with each successive layer using the output from the previous one to inform its results. Deep learning models can become more and more accurate as they process more data, essentially learning from previous results to refine their ability to make correlations and connections. This multi-layered strategy allows deep learning models to complete classification tasks such as identifying subtle textual references.

Unlike other types of AI, deep learning has the added benefit of being able to make decisions with significantly less involvement from human trainers. Although basic AI requires a programmer to identify whether a conclusion is correct or not, deep learning can gauge the accuracy of its answers on its own due to the nature of its multi-layered structure. Deep learning also requires less pre-processing of data. The network itself takes care of many of the filtering and normalization tasks that must be completed by human programmers when using other AI techniques.

For decades, constructing an AI system required careful engineering and considerable domain expertise to design a feature extractor that transformed the raw data into a suitable internal representation or feature vector from which the learning subsystem, often a classifier, could detect or classify patterns in the input. Deep learning networks automatically discover the representations needed for detection or classification, however, reducing the need for supervision and speeding up the process of extracting actionable insights from datasets that have not been as extensively curated. Naturally, the mathematics involved in developing deep learning models are extraordinarily intricate, and there are many different variations of networks that leverage different sub-strategies within the field.

Deep learning has been widely used to tackle challenging natural language processing tasks in recent years. More specifically, the application of deep neural networks in legal analytics has increased significantly (see I. Chalkidis, et al., Artificial Intelligence and Law, 2019). The authors provide a survey in which they study the early adaptation of deep learning in legal analytics focusing on three main fields: text classification, information extraction, and information retrieval. They focus on the semantic feature representations, a key instrument for the successful application of deep learning in natural language processing. In addition, they share pre-trained legal word embeddings using the WORD2VEC model over large corpora, comprising legislation from the United Kingdom, European Union, Canada, Australia, the United States, and Japan, among others.

A need remains for a systematic method for legal text surveillance to collect and analyze laws and policies across jurisdictions or institutions and over time. The method should transform legal text into machine-readable numeric data. The method should be replicable, emphasize transparency, and focus on delivering a highly accurate product through human quality control. AI in general, and specifically ML, and more specifically neural networks, and even more specifically deep learning could better be applied for the systematic collection, analysis, and dissemination of laws and policies across jurisdictions or institutions, and over time.

### SUMMARY OF THE DISCLOSURE

To meet these and other needs, and in view of its purposes, the present disclosure provides an artificial intelligence (AI)-based method for textual identification and feature generation. The method includes: defining a scope including type, time, and geographic dimensions of texts to be analyzed; collecting, identifying, and coding (defined as the process of assigning a code to something for classification or feature identification) selected features of the texts using a pre-defined research procedure and feature set; creating a corpus of machine-readable data and metadata in a software database that includes a scraping tool for searching the worldwide web for text instances and a corpus of text types; interfacing with the software to train an AI assist tool and validate its results; and using the AI assist tool to identify the particular text type and apply the coding protocol to create new and update existing data and metadata. Also provided are a related system and at least one computer-readable non-transitory storage media embodying software.

In another embodiment, the present disclosure provides an AI-based method for the systematic collection, analysis, and dissemination of laws and policies across jurisdictions or institutions, and over time. The method includes: using a pre-defined, routinized, and quality-controlled approach to define a project scope; conducting background research; developing coding questions; collecting the law and creating the legal text; coding the law; publishing and disseminating the data generated; and tracking and updating the law.

Also provided are a related system and at least one computer-readable non-transitory storage media embodying software. The one or more computer-readable non-transitory storage media embodying software is operable when executed, in one embodiment, to: use a pre-defined, routinized, and quality-controlled approach to define a project scope; conduct background research; develop coding questions; collect the law and create the legal text; code the law; publish and disseminate the data generated; and track and update the law.

In one aspect, a method for textual identification and feature generation comprises providing a corpus of texts, defining a scope including type, time, and geographic dimensions of the texts to be analyzed, selecting a subset of the corpus of texts based on the defined scope, collecting, identifying, and manually coding using a coding protocol selected features of the subset of texts using a pre-defined research procedure and feature set, creating a corpus of machine-readable data and metadata in a software database from the coded features of the subset of texts, training an AI assist tool to code the selected features of the subset of texts, using the manually coded features and the subset of texts, and using the trained AI assist tool to apply the coding protocol to create new and update existing data and metadata in the software database.

In one embodiment, the manual coding step comprises the steps of providing the coding protocol and the subset of texts to a plurality of individuals, receiving coded features from the plurality of individuals, comparing the coded features to one another, and providing the coded features to the software database where two or more of the plurality of individuals agree with one another. In one embodiment, the method further comprises the step of calculating a divergence rate from the comparison of the coded features, and decreasing an overlap in an amount of the provided subset of texts when the divergence rate is below a threshold.

In one embodiment, the corpus of texts comprises statutes and judgments. In one embodiment, the method further comprises the step of tagging one or more texts in the corpus of texts with a time stamp. In one embodiment, the method further comprises the step of periodically evaluating an accuracy of the trained AI assist tool by comparing the created and updated data and metadata to data created by an individual. In one embodiment, the method further comprises publishing a subset of the data and metadata in the software database to a public website.

In one aspect, a method for the systematic collection, analysis, and dissemination of laws and policies across jurisdictions or institutions, and over time comprises defining a project scope, conducting background research, developing coding questions, collecting a corpus of law and creating a corpus of legal text, coding the corpus of legal text with a trained artificial intelligence (AI) algorithm, using the coding questions, publishing and disseminating coded corpus of legal text to a software database, and tracking and updating the coded corpus of legal text in the software database.

In one embodiment, the step of defining the project scope comprises selecting a type, time window, and geographic range of the corpus of law. In one embodiment, the step of collecting the corpus of law comprises using a scraping tool to search and retrieve legal text from the Internet. In one embodiment, the step of coding the corpus of legal text comprises the steps of obtaining a prediction job command to a publish/subscribe topic, coding the corpus of legal text with a prediction worker function, storing a prediction result to a cloud storage, and publishing a prediction process finished event to the publish/subscribe topic.

In one embodiment, the step of tracking and updating the coded corpus of legal text in the software database comprises the steps of periodically checking at least one external database of legal text for updates and coding the updates to the corpus of legal text with the trained artificial intelligence (AI) algorithm, using the coding questions. In one embodiment, the corpus of law comprises statutes and ordinances.

In one aspect, a system for collection and analysis of legal text comprises a non-transitory computer-readable storage medium with instructions stored thereon, which when executed by a processor, perform steps comprising accepting a project scope from a user, querying a corpus of legal text using the project scope to obtain a subset of legal text, obtaining a set of coding questions, coding the subset of legal text using the coding questions, and storing the coded subset of legal text in a software database. In one embodiment, the steps further comprise periodically checking at least one external database of legal text for updates to the corpus of legal text, and coding the updates to the corpus of legal text using the coding questions.

In one embodiment, the steps further comprise coding the subset of legal text with a trained artificial intelligence (AI) algorithm. In one embodiment, the steps further comprise accepting a set of manually-coded legal text, comparing the manually-coded legal text to corresponding legal text coded by the trained AI algorithm, and training the AI algorithm with manually coded legal text which differs from the legal text coded by the AI algorithm. In one embodiment, the project scope comprises a type, time window, and geographic range of the corpus of legal text. In one embodiment, the system further comprises a cloud storage communicatively connected to the processor via a network, comprising the software database. In one embodiment, the steps further comprise identifying common terms of art in the corpus of legal text and generating keywords based on the identified common terms of art.

It is to be understood that both the foregoing general description and the following detailed description are exemplary, but are not restrictive, of the disclosure.

### BRIEF DESCRIPTION OF THE DRAWING

The disclosure is best understood from the following detailed description when read in connection with the accompanying drawings. Included in the drawings are the following figures:

FIG. 1A shows an overview illustrating the steps of a method directed generally to legal research and content analysis according to the present disclosure;

FIG. 1B shows an overview illustrating the steps of a method directed generally to human-machine collaboration in legal research and content analysis according to the present disclosure;

FIG. 2 illustrates the second step of the method shown in FIG. 1A according to the present disclosure;

FIG. 3 illustrates the third step of the method shown in FIG. 1A according to the present disclosure;

FIG. 4 illustrates the fourth step of the method shown in FIG. 1A according to the present disclosure;

FIG. 5 illustrates the substep of applying post-production SQC as part of the fifth step of the method shown in FIG. 1A according to the present disclosure;

FIG. 6 illustrates the seventh step of the method shown in FIG. 1A according to the present disclosure;

FIG. 7 illustrates the AI Assist tool used in connection with the method shown in FIG. 1A according to the present disclosure;

FIG. 8A is flow chart that summarizes the steps of an example method implemented using the AI-based system according to the present disclosure;

FIG. 8B is an exemplary system architecture of an AI-based system as disclosed herein.

FIG. 9 illustrates an example network environment associated with an AI-based system and method for textual identification and feature generation;

FIG. 10 illustrates an example computer system; and

FIG. 11 illustrates an example network environment.

### DETAILED DESCRIPTION OF THE DISCLOSURE

In this specification and in the claims that follow, reference will be made to a number of terms which shall be defined to have the following meanings ascribed to them.

The term “about” means those amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is described to be about or about equal to a certain number, the value is within +10% of the number. For example, a value that is about 10 refers to a value between 9 and 11, inclusive. When the term “about” is used in describing a value or an end-point of a range, the disclosure should be understood to include the specific value or end-point. Whether or not a numerical value or end-point of a range in the specification recites “about,” the numerical value or end-point of a range is intended to include two embodiments: one modified by “about” and one not modified by “about.” It will be further understood that the end-points of each of the ranges are significant both in relation to the other end-point and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for components and steps, and ranges thereof, are for illustration only; they do not exclude other defined values or other values within defined ranges. The components and method steps of the disclosure include those having any value or any combination of the values, specific values, more specific values, and preferred values described.

The indefinite article “a” or “an” and its corresponding definite article “the” as used in this disclosure means at least one, or one or more, unless specified otherwise. “Include,” “includes,” “including,” “have,” “has,” “having,” comprise,” “comprises,” “comprising,” or like terms mean encompassing but not limited to, that is, inclusive and not exclusive.

This disclosure is directed to a system using a series of analytical algorithms and to related methods designed to enable subject matter experts (SMEs), which may be human beings or machines, to train AI algorithms to identify and conduct content analysis on selected texts (e.g., laws) to create machine-readable data. SMEs define a text type (e.g., fair housing laws), collect instances, and code selected features into numeric data and metadata. SME-generated data are used to train AI algorithms to identify and code additional instances (e.g., laws from other jurisdictions, new laws, or amended laws) until the AI algorithm attains a high degree of reliability and is able to continue on its own with limited SME involvement.

The phrase “a high degree of reliability” refers to minimal type I or type II errors. In statistical hypothesis testing, a type I error is the mistaken rejection of the null hypothesis, also known as a “false positive” finding or conclusion; for example, “an innocent person is convicted.” A type II error is the mistaken acceptance of the null hypothesis, also known as a “false negative” finding or conclusion; for example, “a guilty person is not convicted.”

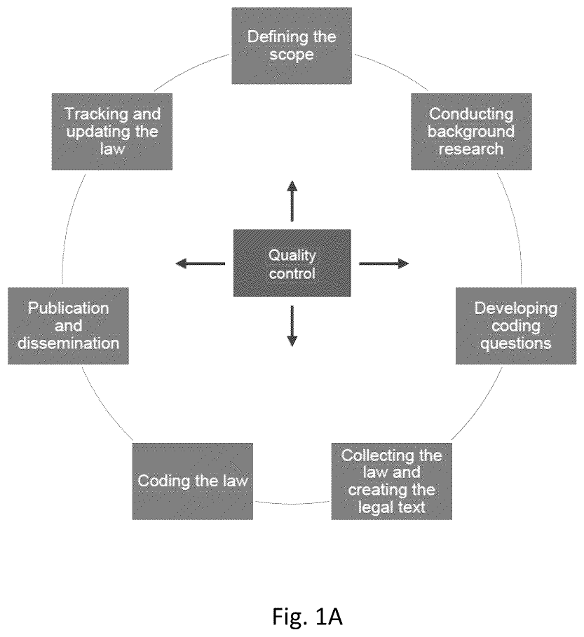

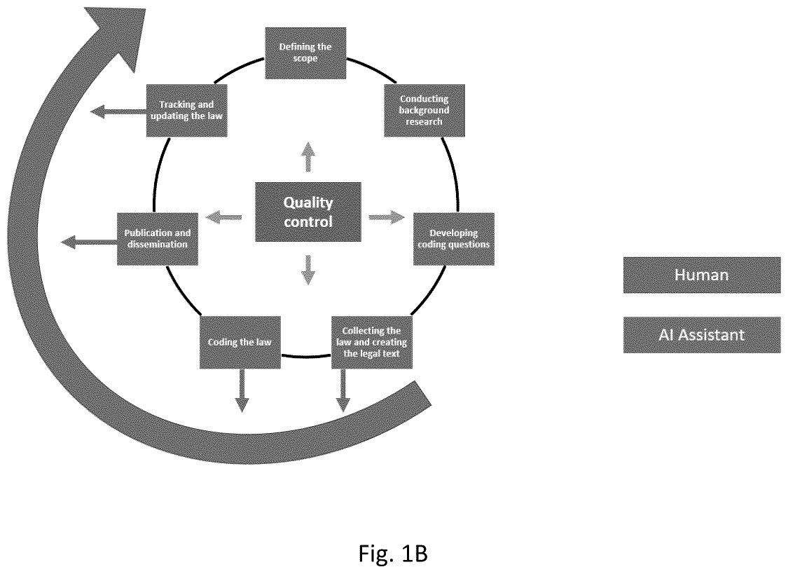

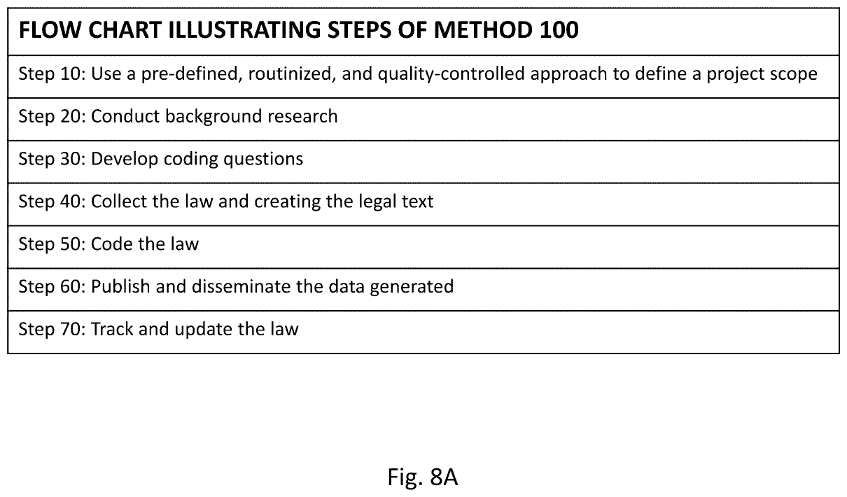

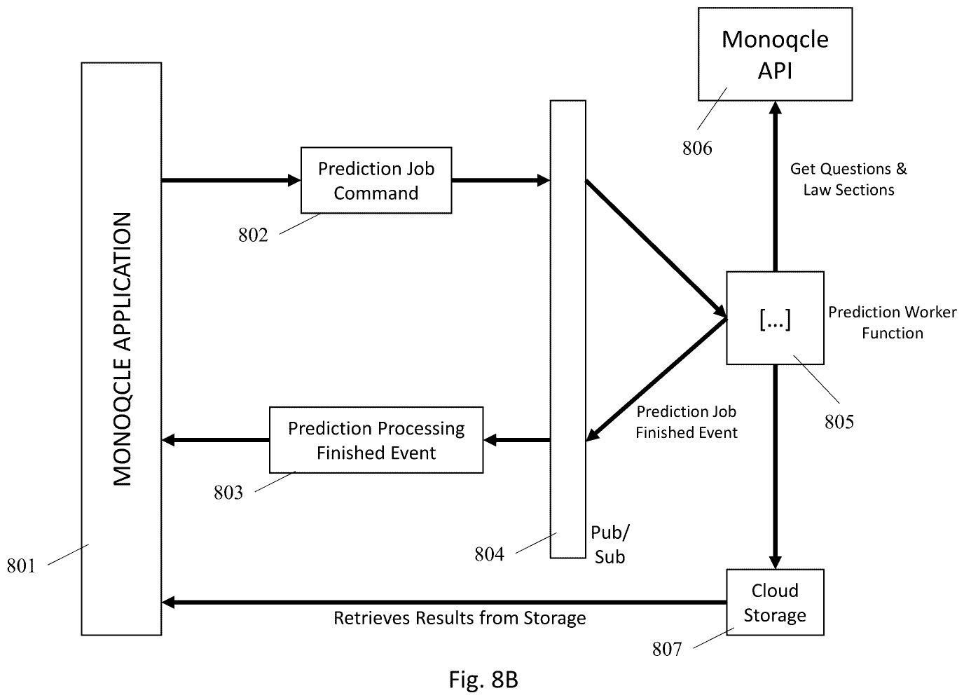

The disclosed method is directed generally to human-machine collaboration in legal research and content analysis. Referring now to the drawings, in which like reference numbers refer to like steps, substeps, or elements throughout the various figures that comprise the drawings, FIG. 1A and FIG. 1B show an overview illustrating a method 100. The steps of the method 100 illustrated in FIG. 1A do not distinguish between whether the steps are performed by a human being or a machine. Preferably, and over time, machines will perform more and more of the steps of the method 100. A tabular listing of the steps of method 100 is shown in FIG. 8A. A machine (the “AI Assistant” or “AI Assist”) can enter the method at step 40, as illustrated in FIG. 8A, of even earlier (e.g., at step 20) in the method 100.

The method 100 has at least three main steps: (A) SMEs define a scope (type, time, and geographic dimensions of texts to be analyzed) then collect, identify, and code selected features of laws or other texts in initial jurisdictions or instances using a pre-defined research procedure and feature set; (B) SMEs use software (e.g., MonQcle) to create a corpus of machine-readable data and metadata in a database that includes a scraping tool for searching the worldwide web for text instances and a corpus of text types (e.g., all municipal ordinances in the United States), and interface with the software to train an AI Assist tool and validate its results; and (C) the AI Assist tool learns to identify the particular text type and apply the coding protocol to create new and update existing data and metadata with diminishing human SME input over time. Each of these three main steps is discussed in more detail below, along with relevant smaller steps encompassed within the main steps.

### A. Define Project Scope, Conduct Background Research, & Code

As an overview, for example, SMEs create a research protocol to identify texts (e.g., laws) within the scope of the topic, and develop a list of the specific features of the law to be observed and transformed into numeric data. Instructions for identifying features (e.g., inclusion and exclusion criteria) may be written into the research protocol. “Scope” is a function of the topic of the text, the set of text creators/auspices to be included (e.g., jurisdictions in which a law might exist), and the time period of observation. The texts may in some embodiments be collected by one or more SMEs working independently (e.g., through legal research in Westlaw or another freely available source). Results are compared and the research protocol adjusted until independent SMEs achieve a designated level of consistency in identifying the relevant text (e.g., 95%). SMEs independently then identify the selected features of the text (e.g., the protected classes or remedies in a fair housing law). Results are compared and the research protocol adjusted until independent SMEs achieve a designated level of consistency in coding (e.g., 95%). In a final quality control check, a sample of identified features is randomly generated and compared against the research and feature identification of a third SME. Results are compared and the research protocol adjusted until independent SMEs achieve a designated level of consistency in a random sample test (e.g., 95%).

With reference to FIG. 1A and FIG. 8A, in the first step 10 of the method 100, SMEs use a pre-defined, routinized, and quality-controlled approach to define the project scope. Scoping identifies the topic and parameters for the project. For example, scoping might identify a category of text (e.g., a type of law such as fair housing) and a set of features to observe (e.g., the protected classes in a fair housing law). Background research helps to define and redefine the scope. When defining the scope of the project, the SME may use several resources and consider logistics carefully. The primary drivers are cost and available resources. Among the factors to be considered when defining the scope of the project are the complexity of the topic (and in-house subject matter expertise), the number of jurisdictions, the number of variables, the level of quality control desired, the dissemination strategy, and the timeline.

The sources that encompass the texts within the scope of the topic may in various embodiments include published and unpublished federal and state court decisions; current and historical statutes; current and historical regulations; ordinances from municipalities such as cities and counties; federal and state dockets and case records; law reviews; and more. These sources make available a large amount of digital legal information.

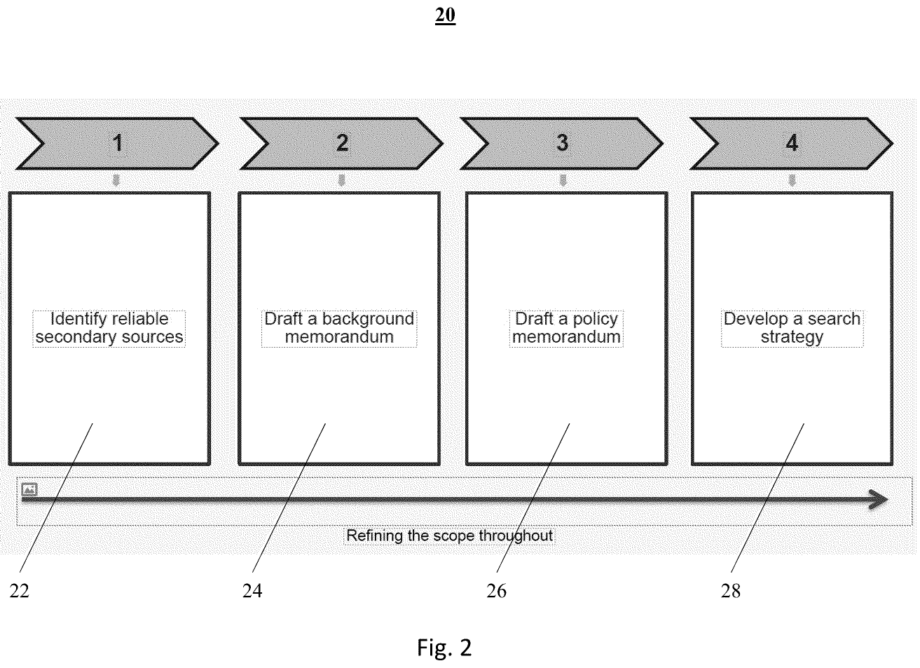

In the second step 20 of the method 100, as illustrated in FIG. 2, SMEs conduct background research. Step 20 may include substep 22 of identifying reliable secondary sources, the substep 24 of drafting a background memorandum, the substep 26 of drafting a policy memorandum, and the substep 28 of developing a search strategy. Reliable secondary sources can include articles, tables, books, websites, and legal datasets. A background memorandum is a document that summarizes and synthesizes the information that has been uncovered about the legal landscape of the topic. The goals of drafting a background memorandum are to familiarize the SMEs with the topic, find gaps in already-existing resources, discover unforeseen challenges, and identify key trends in the law over time. A policy memorandum is a document that summarizes laws in a sample of five jurisdictions that are relevant to the topic. The goals of drafting a policy memorandum are to identify the sources and structure of the law, present a sample of laws relevant to the topic, and identify variations in the law.

In substep 28 of developing a search strategy, multiple search strategies may be used to ensure reliable and accurate research. For example, keywords can be generated by identifying common terms of art relevant to the topic in various jurisdictions and searches can be used to supplement keyword searches when multiple relevant laws are located in the same chapter, index, or table of content. Various measures may be adopted during substep 28 to minimize errors in the search strategy. For example, some jurisdictions may structure their law differently from others, necessitating different search strategies. Search terms and strategies should be recorded during the substep 28, for example on a daily research sheet or research protocol document, including the database used to perform research, the search terms and connectors used, the results yielded by the searches, and notes on the search strategy used. The research protocol outlines the entire methodology and process of the project, including but not limited to: (a) the scope of the project, including dates of the project, SMEs involved, jurisdictions, purpose of the project, and variables; (b) data collection methods, including search strategy and databases used; (c) coding methods, including coding scheme and definitions of terms of art; and (d) description of quality control measures.

In some embodiments, steps 10 and 20 of the method 100 can create a feedback loop in which the background research helps to define and redefine the scope which, in turn, guides further background research. The initial scope of the project sets the parameters for the subject matter to be studied. The scope of the project may change throughout the policy surveillance process.

In the third step 30 of the method 100, coding questions are developed. In the transition from conducting background research in step 20 to developing coding questions in step 30, the legal landscape is investigated, key elements of the law and variation are identified, and preliminary legal constructs are defined. The goals of developing coding questions are to track the state of the law in a question-and-answer format and to create questions that measure and observe the law (rather than questions that interpret the law). Question-and-answer sets capture features of the law from jurisdiction to jurisdiction. Coding questions are used to structure the dataset.

Consider as a preliminary construct example “return to learn” in the education field. Original texts of two state laws include “Guidelines should be provided ‘for limitations and restrictions on school attendance and activities for pupils who have sustained mild traumatic brain injuries, consistent with the directives of the pupil's treating physician’” and “A student and his/her parent(s)/guardian(s) will be informed of the need for an evaluation for brain injury before the student is allowed to return to full participation in school activities including learning.” Initial constructs observed in the law include for example keywords related to the subject matter of the law, for example removal from play, traumatic brain injury (TBI) information sheet, return to learn, parental notification, coach training, prevention measures, and health professional training. Constructs remaining after narrowing the scope include a more limited set of key words, for example removal from play, return to learn, parental notification, and prevention measures. A set of standard constructs may further include jurisdictions (countries, states, cities, counties, organizations, or the like), effective dates, the Federal Information Processing Standard (Alabama-01, Alaska-02, etc.), and the name of the coder or researcher who coded the project.

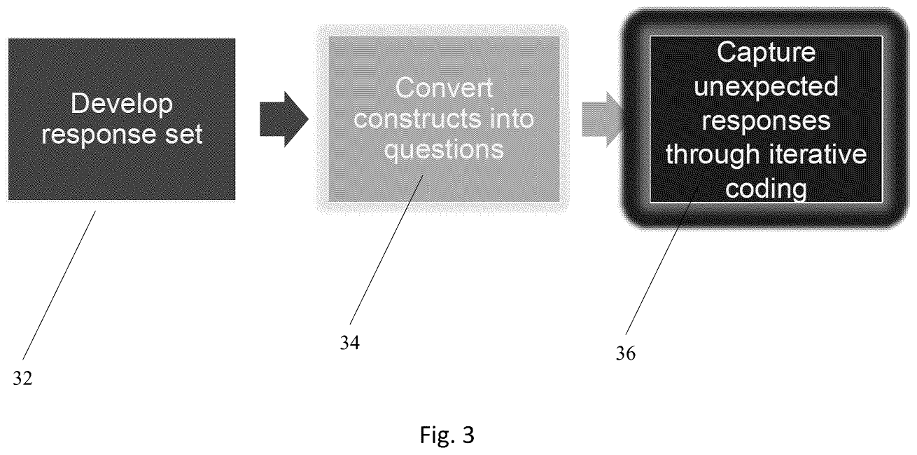

The third step 30 of the method 100 may include, as illustrated in FIG. 3, the substep 32 of developing a response set, the substep 34 of converting constructs into questions, and the substep 36 of capturing unexpected responses through iterative coding. Using the example construct “return to learn measures,” the substep 32 might develop as responses reduced class time, modifications of curriculum, monitoring by health professionals, and monitoring by athletic staff. When converting constructs into questions in substep 34, the distinction between observations (things that can be measured as facts) and interpretations (conclusions that can be derived from observations as opinions) is important. An example observation is: “Does the law specify requirements for a return to learn policy?” An example interpretation is: “Does this state have a strict return to learn policy?” Questions should be observations rather than interpretations. Preferred questions prompt binary (mutually exclusive) answers (yes or no) or categorical answers (selection of one answer from a list of possible answers). The result of step 30 is a table of questions and possible answers.

In the fourth step 40 of the method 100, the law is collected and the legal text is created. Information collected during step 40 may include metadata related to the law, for example citations (a reference to a specific statute or regulation), effective dates (the date when a law goes into force), and statutory history (the legislative session in which the law or amendment was enacted). The legal text is the text of the laws that are relevant to the topic in each jurisdiction, along with any included metadata. In some embodiments, each jurisdiction has its own legal text.

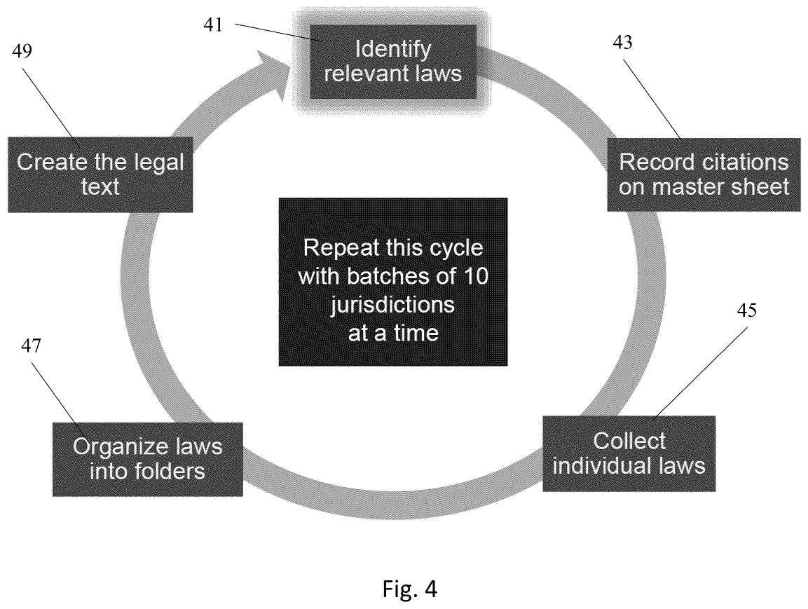

The fourth step 40 of the method 100 may include, as illustrated in FIG. 4, the substep 41 of identifying relevant laws, the substep 43 of recording citations on a master sheet, the substep 45 of collecting individual laws, the substep 47 of organizing the laws into folders (each jurisdiction, for example Alaska, could have its own folder that contains documents relevant to that jurisdiction such as the master sheet, collected laws, and an amendment tracker), and the substep 49 of creating the legal text. An amendment tracker lists amendments to relevant laws in one jurisdiction, in chronological order. The substep 41 can be completed by using the search strategy established during the step 20 of conducting background research to identify laws relevant to the topic in each jurisdiction.

The “master sheet” created in substep 43 records citations of laws that are within the scope of the project, with one master sheet per jurisdiction. For each law, the master sheet may include the citation and title, the statutory history, and the effective dates. The laws in the master sheet may be organized hierarchically by jurisdiction (e.g., federal, state, local), by type of law (e.g., statute, regulation, ordinance), and by chapter and citation number (e.g., 12.55.135 comes before 12.55.150).

In some embodiments, the original research is checked. A supervisor should conduct spot checks in a legal search engine to ensure that the researcher collected all relevant laws, compare collected laws to an unencumbered source of law to ensure that they have been properly transcribed, and verify that master sheets have effective dates and statutory history recorded for each law.

In some embodiments, redundant research should be completed. Redundant research involves two researchers independently identifying and recording citations for relevant laws in one jurisdiction. The goals of redundant research are to define and refine a research strategy, identify errors in original research, and ensure that all relevant law is identified. The steps of redundant research are to assign the redundant research, have multiple researchers complete research for one or more jurisdictions each, have a supervisor compare and review citations of the relevant law, and resolve divergences.

In one example, a supervisor might assign 100% redundant research for the first 10 jurisdictions. When the rate of divergence goes below 5%, the supervisor assigns 50% redundant research. If the rate of divergence remains below 5%, the supervisor then assigns 20% redundant research. The rate of divergence for research in a batch can be calculated using the formula: (Number of divergent laws) divided by (Total number of collected laws) equals (Divergence rate). Divergences may be resolved for example by discussing them among the SMEs, determining the reason for divergence, and resolving the error by including or excluding relevant law.

The legal text is created in the final substep 49 of the step 40. The legal text is the organized version of the relevant law for a jurisdiction. The legal text is both cross-sectional (one legal text exists for one jurisdiction at one point in time) and longitudinal (multiple legal texts for one jurisdiction over a period of time). The legal text is used to code the law. An amendment tracker may also be created to serve as a guide when creating the legal text for a longitudinal project or updating a cross-sectional project.

### B. Create Database and Interfaces

The input of SMEs is provided to a specialized software system, for example “MonQcle,” available at monqcle.com. MonQcle is a software application designed to allow researchers to identify, code, and analyze legal policies and then visualize, share, and update legal research findings. MonQcle allows users to analyze the effects of the law and improve the accuracy and quality of research with the efficiency needed to publish timely findings before they are out of date. More specifically, MonQcle allows users to create datasets that can examine laws and regulations on a topic over time and across jurisdictions; collect, store, and track laws across time and jurisdictions; create quantitative legal data from written legal text; save time and resources updating work over time; and download, publish, and share open-access data. MonQcle was designed to enable the empirical analysis of laws and legal information.

MonQcle transforms text features into machine-readable numeric data and metadata and enables an AI tool to interact with and learn from the (initially human) input. MonQcle comprises three, main components: a database and two interfaces. The database contains text (e.g., legal codes of states and cities), coded data (e.g., the numeric representation of selected features of laws), and various metadata (e.g., a variable representing the legal text associated with a selected feature in the law of a particular jurisdiction during a particular time period). Records in the database encompass all relevant laws and legal citations for a specific jurisdiction at one point in time. The database may be, for example, a NoSQL database. Structured Query Language (SQL) is a domain-specific language used in programming and designed for managing data held in a relational database management system, or for stream processing in a relational data stream management system. SQL is particularly useful in handling structured data, i.e., data incorporating relations among entities and variables. In contrast, NoSQL databases are interchangeably referred to as “non-relational,” “NoSQL DBs,” or “non-SQL” to highlight the fact that they can handle huge volumes of rapidly changing, unstructured data in different ways than a relational (SQL) database with rows and tables. NoSQL databases were introduced in the 1960s, under various names, but are enjoying a surge in popularity as the data landscape shifts and developers adapt to handle the sheer volume and vast array of data generated from the cloud, mobile, social media, and big data.

The first interface of MonQcle allows SMEs to (i) add texts to the database or identify texts already within the database; (ii) create a list of features to be identified in a text in the form of a list of questions with pre-set or open-text answer options that can be applied to every instance of the text (e.g., laws of each of the fifty states in the United States); (iii) view the text for a particular time and place (e.g., the Nevada Fair Housing Law in effect from Jan. 1, 2019 to Jan. 1, 2021) and identify features by selecting one or more pre-set answers or inputting free text; (iv) use a tool (for example, copy and paste) to associate specific words in the text representing the feature with the “answer” on the feature list; and (v) associate a unique identifier (e.g., a statutory citation) with a set of specific words representing the feature and the “answer” on the feature list.

The second interface of MonQcle allows SMEs to (i) review the new instances of texts identified by an AI assistant (called “AI Assist”) (for example, the law in a state not yet researched by SMEs, or amendments to an already-identified and coded law in a particular state) and provide feedback to the AI Assist; (ii) review the features identified by the AI Assist (e.g., the presence or absence of specific protected classes in a fair housing law) and provide feedback to the AI Assist; and (iii) approve the addition of texts and features identified by AI Assist in the dataset.

The MonQcle software and its database were designed with machine-assisted research and coding in mind. The software includes a web-scraping or data-scraping tool. A variety of such tools are commercially available to facilitate the process of gathering large amounts of data online so that the data can be removed, saved, and stored in a separate database. These tools make the task of collecting texts faster and more effective. The MonQcle software also includes software for natural language process (NLP) coding and interaction with SMEs.

In the fifth step 50 of the method 100, the law is coded. The goal of the fifth step 50 is to read, observe, and record the law, rather than to read and interpret the law. The legal text collected in the database is used to answer the questions developed in the third step 30 of the method 100. Coding is done both for legal assessments (cross-sectional), in which the law is coded once for each jurisdiction, capturing a snapshot of the law at one point in time, and for policy surveillance (longitudinal), in which multiple iterations of the law are coded for each jurisdiction, representing different points in time. Longitudinal coding shows the evolution of the law over time; researchers code a new record of the law for each amendment made to the law.

Questions and responses are easily added to MonQcle by clicking an “Add Question” button. Responses (answer choices) can be edited and added throughout the life of a project. Legal text can be cited, pin-cited, and tagged. Cautionary notes can also be added to records. Once a record is created, it can be marked as “finished” and saved.

The initial coding is preferably checked to assure quality (i.e., quality control is performed). As records are coded, a supervisor will typically check for unanswered questions, caution notes, citations, and formatting issues with the legal text. Initial coding checks occur daily, as researchers are coding records. Quality control can also be achieved through redundant coding. Redundant coding identifies problems with the questions, problems with the response set, and coding errors. In redundant coding, multiple researchers independently code identical coding records, then a supervisor compares and reviews these records to determine where the researchers diverge. The rate of divergence can be calculated using the formula: (Number of divergent coded variables) divided by (Total number of coded variables) equals Divergence rate. MonQcle can automatically calculate the rate of divergence.

Two types of divergences can occur. An objective error occurs when one coder answers the questions incorrectly. A subjective error occurs when the coders disagree on a response based on a different reading of the legal text, the question, or an answer choice. Regardless of the type, divergences should be resolved. When there is an objective error, the response should be recoded and additional training may be necessary if a researcher is frequently making objective errors. When there is a subjective error, there are several potential resolutions: modify the question, collect additional law, or edit answer choices.

Divergences, errors, and resolution status can be recorded on a coding review sheet which the team of researchers and supervisors uses to resolve divergences. Researchers may work on the coding review sheet independently and may agree or disagree on a response after revisiting the question and determining the type of divergence at issue. The team of researchers and supervisors may then meet to discuss and resolve any outstanding divergences. Researchers may recode all of their original jurisdictions, as needed.

Once the data are compiled or produced, a process of post-production statistical quality control (SQC) can be applied. SQC describes the process by which a random sample of data is selected and tested to ensure the validity and reliability of the entire dataset. SQC produces a reportable level of confidence on the error rate and bounds for the dataset. For example, SQC might yield as a conclusion: “We are 95% confident that in repeated samples of our datasets there will be an error rate of 5% plus or minus 5%.”

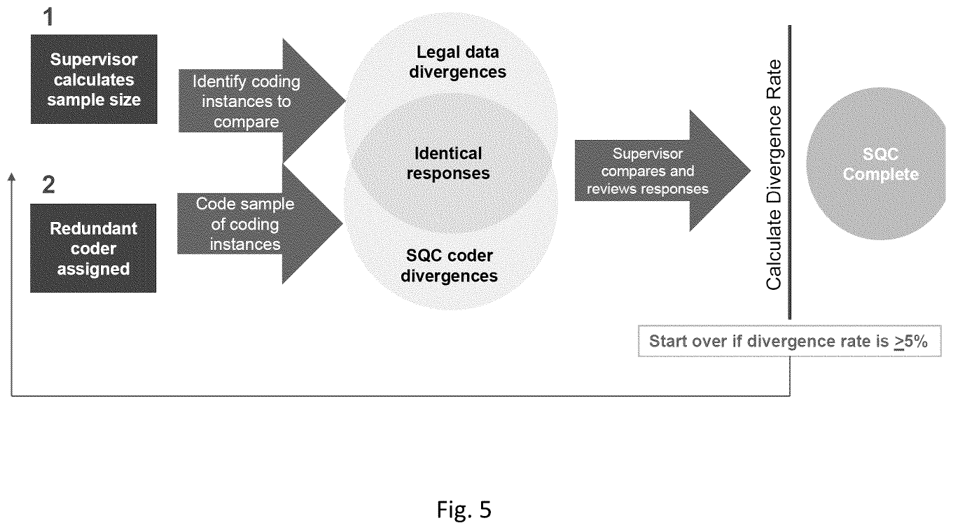

The substep 55 of applying post-production SQC as part of the step 50 of coding the law is illustrated in FIG. 5. The substep 55 includes four actions. First, the exact number of coding instances that need to be selected for SQC is identified. Software can be used to help with this first action. For example, a software product can be used with one or more pre-sets: 5% margin of error, 95% confidence level, 10% response distribution, and a population size based on the specific dataset. A random sample should be used to identify which coding instances to include in the SQC substep 55, and a random number generator bounded by the minimum number (1) and the maximum number (the population size) can help.

In the second action of the substep 55, one or more redundant coders recode the coding instances. A project supervisor may assign the random SQC sample to the researchers. Researchers may be used who, for example, have worked on the project to ensure that the specific coding rules and conventions of the dataset are understood during the SQC process. The original coders should not be assigned their jurisdictions. Researchers will blindly answer “Yes,” “No,” or “N/A” based on how the specific variable should be coded according to the legal text.

In the third action of the substep 55, the project supervisor compares the redundantly coded responses to the original data and calculates a divergence rate. When the SQC divergence rate is lower than a predetermined threshold, for example 5%, the data can be published with confidence as to the results. When the SQC divergence rate is equal to or greater than the predetermined threshold, a new round of SQC may occur until the divergence rate is less than the threshold. Exemplary SQC divergence rate thresholds may be 10%, 9%, 8%, 7%, 6%, 5%, 4%, 3%, 2%, 1%, or any other suitable threshold.

In the fourth and final action of the substep 55, the team meets to discuss and resolve any outstanding divergences. If coding changes are needed, they may be made accordingly. In a longitudinal project, this might require changes in prior iterations. Attention should be given to divergences in grandchild and great-grandchild questions, i.e., parent or grandparent questions related to the outstanding divergences should be checked.

The fifth step 50 of the method 100 concludes with final quality control checks. The supervisor reviews all of the questions, responses, and citations before publishing the project to identify any outstanding issues. Specific checks are done to identify, for example, any questions that were not answered, missing citations, outlier responses, and inconsistent caution notes.

In the sixth step 60 of the method 100, the data generated by the project are published and disseminated. Generally, when publishing data through a website, any publication documents can be used. One such document is the research protocol discussed above as being generated during substep 28 of step 20 of the method 100. The LawAtlas Project, for example, allows publication on lawatlas.org. When using the MonQcle software to publish on LawAtlas, the following documents may in some embodiments be published in addition to the data: essential information (e.g., the research protocol), a legal data file, and a codebook. The MonQcle software automatically generates the legal data file. The codebook is a complete list of all the questions coded in a legal dataset. The codebook includes the question type, the variable name (for comparison with the data file), and the variable values and their labels. The MonQcle software automatically generates the codebook. Optionally, a one-page report may also be published on LawAtlas. In summary, one-click publication is possible with MonQcle, which includes tools (e.g., graphics) that make data visualization both easy and viewer-friendly.

In the seventh and final step 70 of the method 100, the law is tracked and updated. The goal is to update the dataset after the dataset has been compiled. Alerts can be used to trigger “passive” updates to the dataset as new laws and policies are enacted or amended. The dataset can also be reviewed periodically to complete “active” updates.

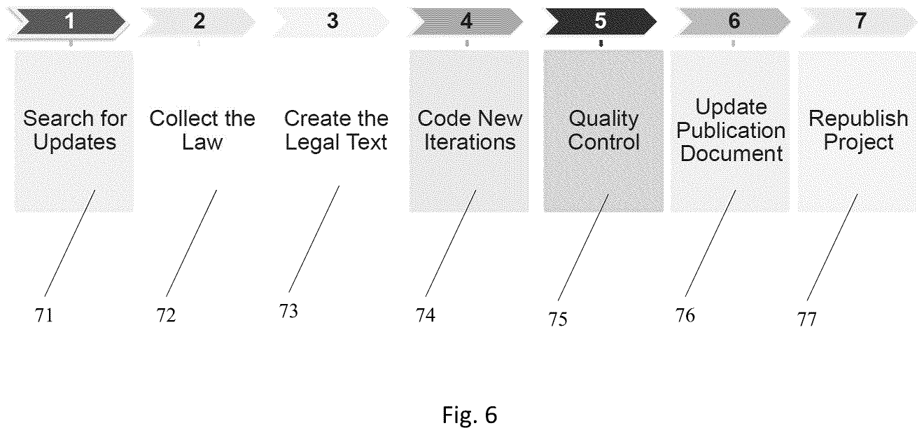

As illustrated in FIG. 6, step 70 may include the substep 71 of searching for updates, the substep 72 of collecting the law, the substep 73 of creating the legal text, the substep 74 of coding new iterations, the substep 75 of quality control, the substep 76 of updating the production document, and the substep 77 of republishing the project. The substep 71 of searching for updates requires researchers to familiarize themselves with the project. In some embodiments, researchers review the coding questions and any background memoranda and read the research protocol.

The researchers may also review the master sheets, which were created in substep 43 of the fourth step 40 of the method 100, and use citations listed on the master sheets (there is one master sheet per jurisdiction). The researchers can verify whether the laws listed on a master sheet of a particular jurisdiction have been amended recently, and update the master sheet accordingly. The researchers can start by entering each citation on the master sheet into a legal search engine. When a law has been amended, the researchers may add the amendment details to the master sheet.

The researchers may also use the search terms listed on the research protocol to find any relevant laws that have been enacted since the last update. This search can be done on a legal search engine or any resource listed in the research protocol from the creation of the original data. New laws should be added to the master sheet along with their statutory histories and effective dates.

### C. Incorporate an AI Assist Tool

An AI Assist feature is configured to search for new instances of the text and generate its proposal of the features observed in a dataset. A simple and automatically learning AI assistant uses at least AI, ML, and reinforcement learning (RL) patterns to automatically identify texts within the scope of a dataset (e.g., new versions of a law), automatically generate features of the text, automatically update underlying training models, propose texts and features to a SME, and, as authorized, update datasets as new versions of the target text are created. In the legal example, the AI Assist may be configured to add additional jurisdictions to a dataset being constructed or to update a completed dataset as new laws are passed. As the AI Assist achieves designated levels of accuracy in identifying and coding texts, its results can be accepted—with SME involvement limited to random quality control. The following is a detailed description of an exemplary AI Assist feature of the present disclosure.

The input of SMEs may be initially required to train the AI Assist, specifically any selection on an input dataset which reduces the likelihood of false positives in the input dataset. A typical task would be choosing the correct version of a state fair housing law, for example, given the law of an entire state as input. When the SME selects a text, the model also predicts the text. When the model reaches a threshold of accuracy considered meaningful (e.g., 80% accurate), the interface notifies the SME that meaningful prediction is possible. The SME is then shown a list of model-predicted texts. The SME selects the correct citation and alters the citation (if necessary) to make it correct. The model is then updated via this input, and the next prediction is more accurate, and so on, until the human user is only verifying the prediction of the model.

In addition to the model prediction, a template of features is presented after a text is identified for inclusion in the dataset. This template, (e.g., a fair housing law) can be as simple as an array of named arrays, for example [key, value] pairs, constituting features or sub features of interest, i.e. [{“key”: “race,” values: [“ethnicity,” “skin color”] } ]. Much like the previous step, this information is displayed to the SME, and then a sub-model predicts the feature selection while the SME determines the ground truth. If the SME discovers additional features, the SME may then add them (e.g., if jurisdictions begin to add a distinct new feature to a law that the AI Assist has already “learned”). Like the previous step, when the prediction by the model reaches a threshold of accuracy, the model notifies the interface that meaningful prediction is possible, and then begins to identify the features within the text as well.

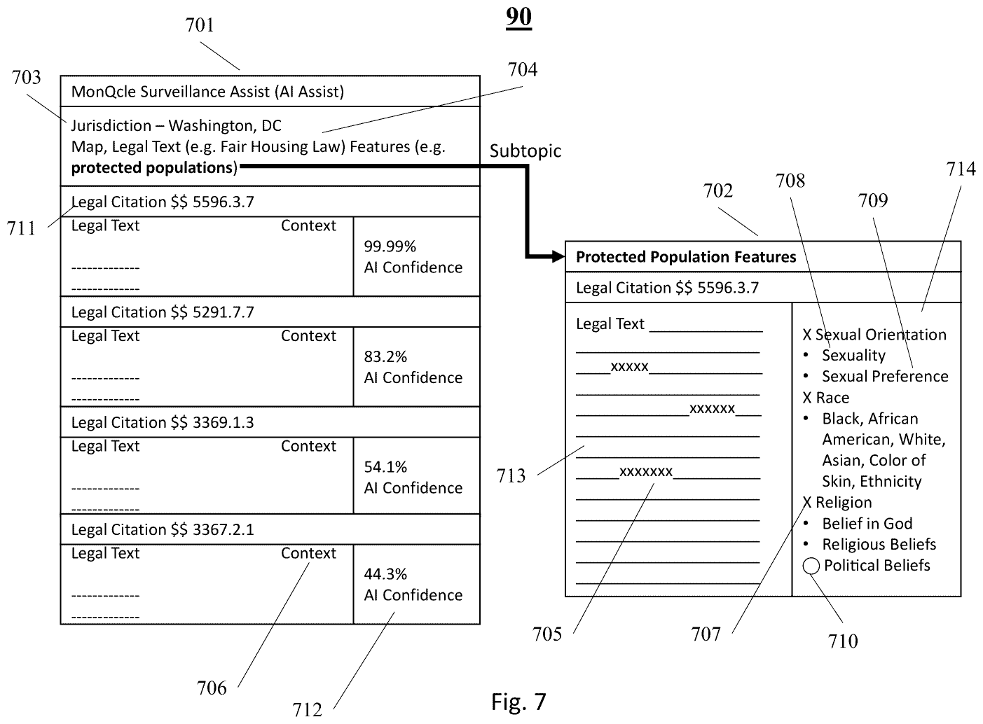

The AI Assist tool 90 is illustrated in FIG. 7, with two general dialog boxes labeled with the numbers “1” and “2.” The AI Assist tool 90 functions to speed up both the AI learning process and the work of the SMEs, with each subsequent jurisdiction, citation, and feature marking becoming more and more accurate as the model retrains, eventually becoming a confirmation process without needing adjustment. As illustrated in FIG. 7, and for purposes of example, the AI Assist tool 90 is applied to a legal text.

The jurisdiction 703 is shown on the top left of the dialog box 701, namely Washington, D.C. in this example, the GUI includes a link to a map and the full jurisdiction text. The topic 704 being surveyed (“Fair Housing Law”) is shown on the top right of the dialog box 701, along with a subtopic (“Protected Population”) if one exists. The citation 711 (the official identifier of the law, “SS 5596.3.7” in the example) is identified along with the text of the law. The level of AI confidence 712 that it is correct, based on the model as trained so far, is shown (for example 99.99% for the top cited law in dialog box 701). A click on the confidence score may bring the user to dialog box 702. Links 706 are provided, labeled “Context,” allowing the user to view the text segment in context, in order to expand or contract the cited text if needed.

Dialog box 702 identifies features for the subtopic “Protected Population.” The relevant legal text 713 is presented. One or more features 714 are identified, with the text that constitutes the feature 705 highlighted in the text display. The identified features are listed by a checkbox (707, 710). The checkboxes may be auto-selected for features found, but can be unselected, for example 710 if incorrect). In this example, “Sexual Orientation” is a protected population. Known feature mutations 708, 709 are identified (e.g., “Sexuality” and “Sexual preference” are mutations of “Sexual orientation”). The identified feature mutation may be highlighted (in the selector and/or in the citation). In some embodiments, an “Add” button (not shown) allows the user to add a new feature. A check box 707, 710 allows the user to check a feature and mark it manually if the feature is not found. An unchecked box 710 allows the user to uncheck a feature and combat false negatives. Finally, feature mutations can be added in the field 714.

The AI model may be retrained when one or more of the following events occurs: the SME (or machine) selects a citation 711 in the topic assistant as correct; the SME adjusts a citation 711; the SME adds a feature 714; the SME checks and marks a feature 714 not automatically identified, the SME unchecks a feature (e.g. 710) that was incorrectly identified, or the SME adds a feature mutation (e.g. 709). From this process, the AI model may automatically adjust internal deep neural connections without input or human assistance, to: (i) identify any relevant citations for a topic or subtopic (or tertiary or further subtopic) within any text; (ii) mark the text, even across paragraphs, parts of other paragraphs, and so on; and (iii) identify any features within that text, such as the protected populations for fair housing, or the number of days required for an eviction notice, etc.

Some limitations should be noted for the AI model. Particularly, the model will produce literal random results until the SME starts marking text and features. Confidence is gained as the model makes predictions and gets feedback as to what the SME actually did. Once the model reaches about 50% confidence, the AI Assist becomes a viable tool for the topic. The number of texts and features a human (or machine) must identify before this threshold is reached varies by topic, and in some embodiments is assumed to be 5-10.

As discussed above, the method 100 has at least three main steps: (A) define the project scope, conduct background research, and code; (B) create a database and interfaces; and (C) incorporate an AI Assist tool. The method 100 can also be considered to include three main elements: (I) human processes, (II) MonQcle data automation and storage, and (III) AI Assist functions. The roles that each of these three elements play in various steps of the method 100 are discussed below, with respect to one specific embodiment.

During the initial step 20 of conducting background research, human processes (I) oversee the scope and quality control of the corpus of law; define the type of law; extract instances from n jurisdictions from the corpus; trigger and define the AI training; and verify AI returns. The MonQcle software (II) contains the corpus of law from research jurisdictions; creates a record for each time/place/text set defined by the human processes (I) or the AI Assist functions (III); and provides the user interface (UI) for the human processes (I) to assure quality control and oversight of the corpus, define tasks for the AI Assist functions (III), and verify and correct the AI Assist functions (III). Finally, the AI Assist functions (III) identify and retrieve instances from the corpus of jurisdictional law; learn from interaction with the human processes (I) and continue to identify new instances; and perform other tasks (e.g., translate legal text, verify legal text as official, and more).

During the step 50 of coding the law, human processes (I) define a coding scheme; code the n jurisdictions; and verify AI coding proposals. The MonQcle software (II) provides the user interface for the human processes (I) to code and links text and metadata to coded answers; creates a record for each time/place/text set defined by the human processes (I) or the AI Assist functions (III); and provides the user interface for the human processes (I) to define tasks for the AI Assist functions (III) and to verify and correct the AI Assist functions (III). Finally, the AI Assist functions (III) learn the coding scheme by studying the coded data and metadata of the n jurisdictions created by the human processes (I) and propose coding for additional jurisdictions.

More specifically, as longitudinal research is conducted during the step 50 of coding the law, human processes (I) create a training set of laws of n jurisdictions from the earliest included date; code the n jurisdictions; verify the returns from the AI Assist functions (III); and verify the coding done by the AI Assist functions (III). The MonQcle software (II) contains the corpus of law for the included time and jurisdictions; creates records; allows the human processes (I) and the AI Assist functions (III) to compare versions of legal text within jurisdictions to identify changes; and provides the user interface for the human processes (I) to assign and verify research and coding. Finally, the AI Assist functions (III) learn to retrieve each temporal iteration of law for each jurisdiction from the corpus; learn the coding scheme; and compare earlier law and propose coding for each retrieved iteration.

Finally, during the step 70 of tracking and updating the law, human processes (I) verify the returns and coding from the AI Assist functions (III) and adjust the research protocol and coding scheme to reflect significant changes in law. The MonQcle software (II) contains the corpus of law for the included time and jurisdictions; updates the corpus daily; creates records; allows the human processes (I) and the AI Assist functions (III) to compare versions of legal text within jurisdictions to identify changes; and provides the user interface for the human processes (I) to assign and verify research and coding. Finally, the AI Assist functions (III) identify changes in the corpus; identify changes in the coded law; and compare earlier law and propose coding for each new iteration.

Each of the components described above in connection with the method 100 is one component of the AI-based system. Such components include, among others, texts, the MonQcle software, the AI Assist tool 90 (see FIG. 7), the NoSQL database, and LawAtlas. FIG. 8A is flow chart that summarizes the steps of the example method 100 implemented using the AI-based system. Those steps include the following:
Step 10: Use a pre-defined, routinized, and quality-controlled approach to define a project scope;
Step 20: Conduct background research;
Step 30: Develop coding questions;
Step 40: Collect the law and create the legal text;
Step 50: Code the law;
Step 60: Publish and disseminate the data generated; and
Step 70: Track and update the law.

Details about each of the steps have been provided above in the context of describing the method 100 and the related AI-based system.

With reference to FIG. 8B, a diagram of an exemplary system architecture of an AI-based system is shown. The main functionality of the exemplary system is to search through sections of documents, for example law documents, and identify the parts of the text (citations) that answer the provided questions. The law text and questions are received from an external system, and the results may be transmitted via any communication protocol, for example JSON. The architecture may be set up as event-driven, i.e. the function may be invoked via messages or commands sent to a publish/subscribe (pub/sub) topic. The depicted architecture in FIG. 8B is provided as an addition to an existing software interface 801, which in FIG. 8B is MonoQcle.

An exemplary embodiment of the architecture may first accept input commands (for example prediction job command 802) from application 801. The prediction job command may be published to a pub/sub topic 804, and may contain information about the law dataset and questions that are to be answered. The prediction job command may further comprise metadata including unique identifiers for the command, the organization/requestor, the dataset being accessed, the bounds of the request (e.g jurisdiction and time) and the question. The prediction job command is then accessed from the pub/sub 804 by prediction worker function 805. The prediction worker function may then query an application programming interface (API) 806, for example the MonoQcle API, for questions and relevant law sections.

Once the worker function 805 completes the prediction task, it stores the prediction result in a cloud storage 807, and publishes a prediction job finished event 803 to the pub/sub 804. The application 801 retrieves the prediction job finished event 803, which contains unique identifiers related to the original request 802, and also information regarding where the result itself is located in cloud storage 807. Finally, the application 801 retrieves the result itself from cloud storage 807 to provide to the requesting user or application.

In some embodiments, an architecture may comprise an internal queueing mechanism (not shown) configured to re-queue prediction job commands 802 that time out due to long processing times or lack of availability of prediction worker functions 805. The queueing mechanism may comprise, for example, a progress indicator in the prediction job command which can indicate whether a subset of the questions contained in the prediction job command 802 have been completed. This will ensure that a future worker function 805 which begins working on the partially-completed prediction command does not duplicate the effort of prior iterations.

The prediction worker function 805 may perform an algorithm comprising steps of parsing the received command 802 and extracting relevant parameters, retrieving law sections and questions from the API 806, selecting at least a subset of question(s) contained in the command 802 to run, passing the questions and law sections to a trained AI model to obtain predictions, write the results to the cloud storage 807, and send the prediction processing finished event 803 to the application 801 via the pub/sub 804.

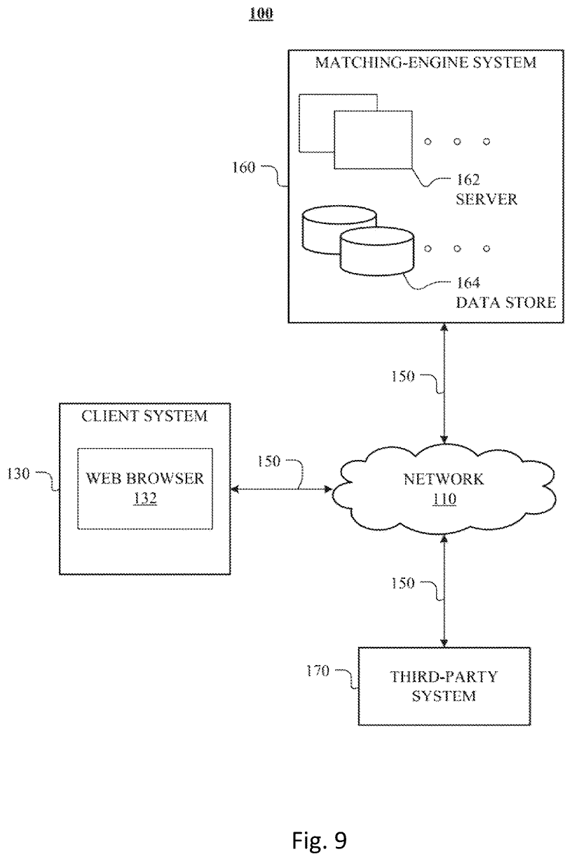

FIG. 9 illustrates an example network environment 120 associated with the AI-based system. The network environment 120 includes a client system 130, the AI-based system, and a third-party system 170 connected to each other by a network 110. Although FIG. 9 illustrates a particular arrangement of the client system 130, the AI-based system, the third-party system 170, and the network 110, this disclosure contemplates any suitable arrangement of the client system 130, the AI-based system, the third-party system 170, and the network 110. As an example and not by way of limitation, two or more of the client system 130, the AI-based system, and the third-party system 170 may be connected to each other directly, bypassing the network 110. As another example, two or more of the client system 130, the AI-based system, and the third-party system 170 may be physically or logically co-located with each other in whole or in part. Moreover, although FIG. 9 illustrates a particular number of client systems 130, AI-based systems, third-party systems 170, and networks 110, this disclosure contemplates any suitable number of client systems 130, AI-based systems, third-party systems 170, and networks 110. As an example and not by way of limitation, the network environment 120 may include multiple client systems 130, AI-based systems, third-party systems 170, and networks 110.

This disclosure contemplates any suitable network 110. As an example and not by way of limitation, one or more portions of the network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 110 may include one or more networks 110.

One or more links 150 may connect the client system 130, the AI-based system, and the third-party system 170 to the communication network 110 or to each other. This disclosure contemplates any suitable links 150. In particular embodiments, the one or more links 150 include one or more wireline (such as, for example, Digital Subscriber Line (DSL) or Data Over Cable Service Interface Specification (DOC SIS)), wireless (such as, for example, Wi-Fi or Worldwide Interoperability for Microwave Access (WiMAX)), or optical (such as, for example, Synchronous Optical Network (SONET) or Synchronous Digital Hierarchy (SDH)) links. In particular embodiments, the one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. The links 150 need not necessarily be the same throughout the network environment 120. The one or more first links 150 may differ in one or more respects from one or more second links 150.

In particular embodiments, the client system 130 may be an electronic device including hardware, software, or embedded logic components or a combination of two or more such components and capable of carrying out the appropriate functionalities implemented or supported by the client system 130. As an example and not by way of limitation, the client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. The client system 130 may enable a network user at the client system 130 to access the network 110. The client system 130 may enable its user to communicate with other users at other client systems 130.

In particular embodiments, the client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user of the client system 130 may enter a Uniform Resource Locator (URL) or other address directing the web browser 132 to a particular server (such as a server 162, or a server associated with a third-party system 170), and the web browser 132 may generate a Hyper Text Transfer Protocol (HTTP) request and communicate the HTTP request to the server. The server may accept the HTTP request and communicate to the client system 130 one or more Hyper Text Markup Language (HTML) files responsive to the HTTP request. The client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. In this document, reference to a webpage encompasses one or more corresponding webpage files (which a browser may use to render the webpage) and vice versa, where appropriate.

In particular embodiments, the AI-based system may be a network-addressable computing system that can host an online analytical engine. The AI-based system may generate, store, receive, and send data related to the analytical engine, subject to laws and regulations regarding that data. The AI-based system may be accessed by the other components of the network environment 120 either directly or via the network 110. In particular embodiments, the AI-based system may receive inputs from one or more of a performance engine or an experience engine (which may be independent systems or sub-systems of the AI-based system). The performance engine may receive data. The experience engine may receive data. In particular embodiments, the AI-based system may include one or more servers 162. Each server 162 may be a unitary server or a distributed server spanning multiple computers or multiple datacenters. The servers 162 may be of various types, such as, for example and without limitation, web server, news server, mail server, message server, advertising server, file server, application server, exchange server, database server, proxy server, another server suitable for performing functions or processes described in this document, or any combination thereof. In particular embodiments, each server 162 may include hardware, software, or embedded logic components or a combination of two or more such components for carrying out the appropriate functionalities implemented or supported by the server 162. In particular embodiments, the AI-based system may include one or more data stores 164. The data stores 164 may be used to store various types of information. In particular embodiments, the information stored in the data stores 164 may be organized according to specific data structures. In particular embodiments, each data store 164 may be a relational, columnar, correlation, or another suitable database. Although this disclosure describes or illustrates particular types of databases, this disclosure contemplates any suitable types of databases. Particular embodiments may provide interfaces that enable the client system 130, the AI-based system, or the third-party system 170 to manage, retrieve, modify, add, or delete, the information stored in the data store 164.

In particular embodiments, the AI-based system may be capable of linking a variety of entities. As an example and not by way of limitation, the AI-based system may enable users to interact with each other as well as receive content from the third-party systems 170 or other entities, or allow users to interact with these entities through an application programming interface (API) or other communication channels.

In particular embodiments, the third-party system 170 may include one or more types of servers, one or more data stores, one or more interfaces, including but not limited to APIs, one or more web services, one or more content sources, one or more networks, or any other suitable components, e.g., with which servers may communicate. The third-party system 170 may be operated by a different entity from an entity operating the AI-based system. In particular embodiments, however, the AI-based system and the third-party systems 170 may operate in conjunction with each other to provide services to users of the AI-based system or the third-party systems 170. In this sense, the AI-based system may provide a platform, or backbone, which other systems, such as the third-party systems 170, may use to provide services and functionality to users across the Internet.

In particular embodiments, the AI-based system also includes user-generated content objects, which may enhance the interactions of a user with the AI-based system. User-generated content may include anything a user can add, upload, send, or “post” to the AI-based system. In particular embodiments, user-generated content may comprise user-profile information. As an example and not by way of limitation, a user communicates posts to the AI-based system from the client system 130. Posts may include data such as legal records, other textual data, location information, graphs, videos, links, or other similar data or content. Content may also be added to the AI-based system by a third-party through a suitable communication channel.

In particular embodiments, the AI-based system may include a variety of servers, sub-systems, programs, modules, logs, and data stores. In particular embodiments, the AI-based system may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user/patient-profile store, connection store, third-party content store, or location store. The AI-based system may also include suitable components such as network interfaces, security mechanisms, load balancers, failover servers, management-and-network-operations consoles, other suitable components, or any suitable combination thereof. In particular embodiments, the AI-based system may include one or more user-profile stores for storing user profiles. A user/researcher profile may include, for example, legal information, biographic information, demographic information, behavioral information, social information, or other types of descriptive information, such as work experience, educational history, hobbies or preferences, interests, affinities, or location. A web server may be used to link the AI-based system to one or more client systems 130 or one or more third-party systems 170 via the network 110. The web server may include a mail server or other messaging functionality for receiving and routing messages between the AI-based system and one or more of the client systems 130. An API-request server may allow the third-party system 170 to access information from the AI-based system by calling one or more APIs. An action logger may be used to receive communications from a web server about the actions of a user on or off the AI-based system. In conjunction with the action log, a third-party-content-object log may be maintained of user exposures to third-party-content objects. A notification controller may provide information regarding content objects to the client system 130. Information may be pushed to the client system 130 as notifications, or information may be pulled from the client system 130 responsive to a request received from the client system 130. Authorization servers may be used to enforce one or more privacy settings of the users of the AI-based system. A privacy setting of a user determines how particular information associated with a user can be shared. The authorization server may allow users to opt in to or opt out of having their actions logged by the AI-based system or shared with other systems (e.g., the third-party system 170), such as, for example, by setting appropriate privacy settings. Third-party-content-object stores may be used to store content objects received from third parties, such as the third-party system 170. Location stores may be used to store location information received from the client system 130 associated with users.

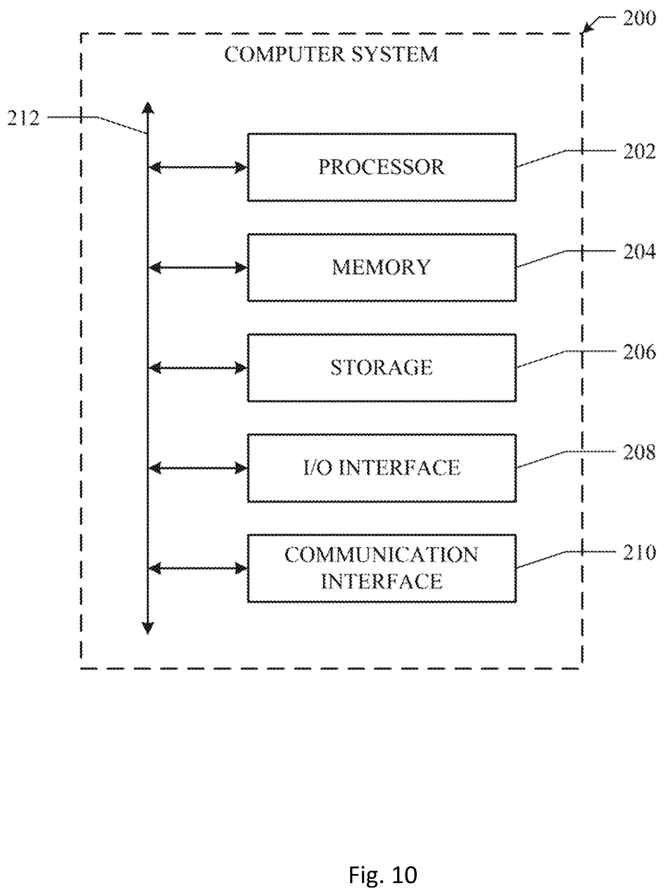

FIG. 10 illustrates an example computer system 200. In particular embodiments, one or more computer systems 200 perform one or more steps of one or more methods described or illustrated in this document. In particular embodiments, one or more computer systems 200 provide functionality described or illustrated in this document. In particular embodiments, software running on one or more computer systems 200 performs one or more steps of one or more methods described or illustrated in this document or provides functionality described or illustrated in this document. Particular embodiments include one or more portions of one or more computer systems 200. In this document, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates the computer system 200 taking any suitable physical form. As example and not by way of limitation, the computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these devices. Where appropriate, the computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated in this document. As an example and not by way of limitation, the one or more computer systems 200 may perform in real time or in batch mode one or more steps of one or more methods described or illustrated in this document. The one or more computer systems 200 may perform at different times or at different locations one or more steps of one or more methods described or illustrated in this document, where appropriate.

In particular embodiments, the computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 202 includes hardware for executing instructions, such as those making up a computer program. As an example and not by way of limitation, to execute instructions, the processor 202 may retrieve (or fetch) the instructions from an internal register, an internal cache, the memory 204, or the storage 206; decode and execute them; and then write one or more results to an internal register, an internal cache, the memory 204, or the storage 206. In particular embodiments, the processor 202 may include one or more internal caches for data, instructions, or addresses. This disclosure contemplates the processor 202 including any suitable number of any suitable internal caches, where appropriate. As an example and not by way of limitation, the processor 202 may include one or more instruction caches, one or more data caches, and one or more translation lookaside buffers (TLBs). Instructions in the instruction caches may be copies of instructions in the memory 204 or the storage 206, and the instruction caches may speed up retrieval of those instructions by the processor 202. Data in the data caches may be copies of data in the memory 204 or the storage 206 for instructions executing at the processor 202 to operate on; the results of previous instructions executed at the processor 202 for access by subsequent instructions executing at the processor 202 or for writing to the memory 204 or the storage 206; or other suitable data. The data caches may speed up read or write operations by the processor 202. The TLBs may speed up virtual-address translation for the processor 202. In particular embodiments, the processor 202 may include one or more internal registers for data, instructions, or addresses. This disclosure contemplates the processor 202 including any suitable number of any suitable internal registers, where appropriate. Where appropriate, the processor 202 may include one or more arithmetic logic units (ALUs); be a multi-core processor; or include one or more processors 202. Although this disclosure describes and illustrates a particular processor, this disclosure contemplates any suitable processor.

In particular embodiments, the memory 204 includes main memory for storing instructions for the processor 202 to execute or data for the processor 202 to operate on. As an example and not by way of limitation, the computer system 200 may load instructions from the storage 206 or another source (such as, for example, another computer system 200) to the memory 204. The processor 202 may then load the instructions from the memory 204 to an internal register or internal cache. To execute the instructions, the processor 202 may retrieve the instructions from the internal register or internal cache and decode them. During or after execution of the instructions, the processor 202 may write one or more results (which may be intermediate or final results) to the internal register or internal cache. The processor 202 may then write one or more of those results to the memory 204. In particular embodiments, the processor 202 executes only instructions in one or more internal registers or internal caches or in the memory 204 (as opposed to the storage 206 or elsewhere) and operates only on data in one or more internal registers or internal caches or in the memory 204 (as opposed to the storage 206 or elsewhere). One or more memory buses (which may each include an address bus and a data bus) may couple the processor 202 to the memory 204. The bus 212 may include one or more memory buses, as described below. In particular embodiments, one or more memory management units (MMUs) reside between the processor 202 and the memory 204 and facilitate accesses to the memory 204 requested by the processor 202. In particular embodiments, the memory 204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. The memory 204 may include one or more memories 204, where appropriate. Although this disclosure describes and illustrates particular memory, this disclosure contemplates any suitable memory.

In particular embodiments, the storage 206 includes mass storage for data or instructions. As an example and not by way of limitation, the storage 206 may include a hard disk drive (HDD), a floppy disk drive, flash memory, an optical disc, a magneto-optical disc, magnetic tape, or a Universal Serial Bus (USB) drive or a combination of two or more of these. The storage 206 may include removable or non-removable (or fixed) media, where appropriate. The storage 206 may be internal or external to the computer system 200, where appropriate. In particular embodiments, the storage 206 is non-volatile, solid-state memory. In particular embodiments, the storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates the storage 206 taking any suitable physical form. The storage 206 may include one or more storage control units facilitating communication between the processor 202 and the storage 206, where appropriate. Where appropriate, the storage 206 may include one or more storages 206. Although this disclosure describes and illustrates particular storage, this disclosure contemplates any suitable storage.

In particular embodiments, the I/O interface 208 includes hardware, software, or both, providing one or more interfaces for communication between the computer system 200 and one or more I/O devices. The computer system 200 may include one or more of these I/O devices, where appropriate. One or more of these I/O devices may enable communication between a person and the computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, the I/O interface 208 may include one or more device or software drivers enabling the processor 202 to drive one or more of these I/O devices. The I/O interface 208 may include one or more I/O interfaces 208, where appropriate. Although this disclosure describes and illustrates a particular I/O interface, this disclosure contemplates any suitable I/O interface.

In particular embodiments, the communication interface 210 includes hardware, software, or both providing one or more interfaces for communication (such as, for example, packet-based communication) between the computer system 200 and one or more other computer systems 200 or one or more networks. As an example and not by way of limitation, the communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, the computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. The computer system 200 may include any suitable communication interface 210 for any of these networks, where appropriate. The communication interface 210 may include one or more communication interfaces 210, where appropriate. Although this disclosure describes and illustrates a particular communication interface, this disclosure contemplates any suitable communication interface.

In particular embodiments, the bus 212 includes hardware, software, or both coupling components of the computer system 200 to each other. As an example and not by way of limitation, the bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus 212 may include one or more buses 212, where appropriate. Although this disclosure describes and illustrates a particular bus, this disclosure contemplates any suitable bus or interconnect.

In this document, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of the processor 202 (such as, for example, one or more internal registers or caches), one or more portions of the memory 204, one or more portions of the storage 206, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. In this document, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), JavaScript Object Notation (JSON) or other suitable markup language.

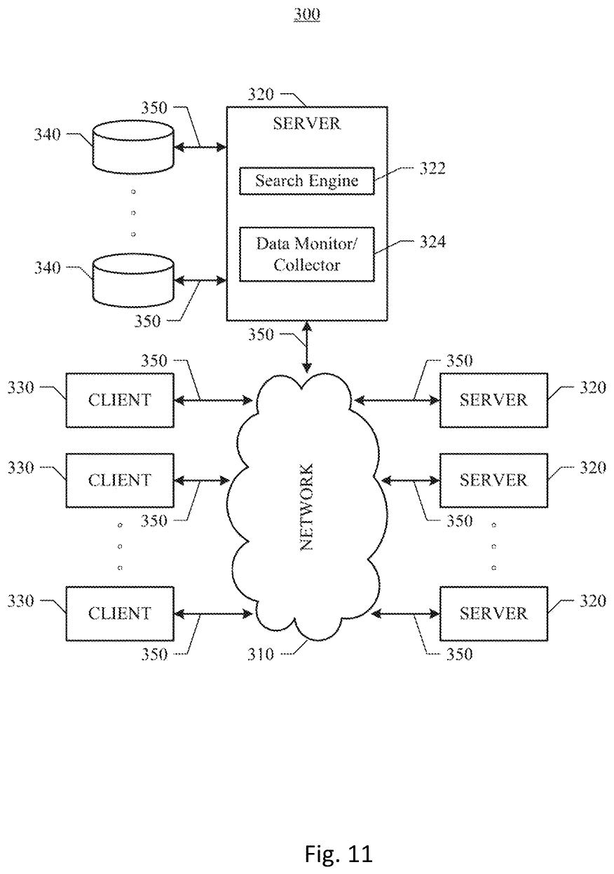

FIG. 11 illustrates an example network environment 300. This disclosure contemplates any suitable network environment 300. As an example and not by way of limitation, although this disclosure describes and illustrates the network environment 300 as implementing a client-server model, this disclosure contemplates one or more portions of the network environment 300 being peer-to-peer, where appropriate. Particular embodiments may operate in whole or in part in one or more network environments 300. In particular embodiments, one or more elements of the network environment 300 provide functionality described or illustrated in this document. Particular embodiments include one or more portions of the network environment 300. The network environment 300 includes a network 310 coupling one or more servers 320 and one or more clients 330 to each other. This disclosure contemplates any suitable network 310. As an example and not by way of limitation, one or more portions of the network 310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 310 may include one or more networks 310.

One or more links 350 couple the servers 320 and the clients 330 to the network 310 or to each other. This disclosure contemplates any suitable links 350. As an example and not by way of limitation, the one or more links 350 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 350. In particular embodiments, the one or more links 350 each includes an intranet, an extranet, a VPN, a LAN, a WLAN, a WAN, a MAN, a communications network, a satellite network, a portion of the Internet, or another link 350 or a combination of two or more such links 350. The links 350 need not necessarily be the same throughout the network environment 300. One or more first links 350 may differ in one or more respects from one or more second links 350.

This disclosure contemplates any suitable servers 320. As an example and not by way of limitation, one or more servers 320 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, the server 320 includes hardware, software, or both for providing the functionality of the server 320. As an example and not by way of limitation, the server 320 operates as a web server and may be capable of hosting websites containing web pages or elements of web pages and includes appropriate hardware, software, or both for doing so. In particular embodiments, a web server may host HTML or other suitable files or dynamically create or constitute files for web pages on request. In response to a Hyper Text Transfer Protocol (HTTP) or other request from the client 330, the web server may communicate one or more such files to the client 330. As another example, the server 320 that operates as a mail server may be capable of providing e-mail services to one or more clients 330. As another example, the server 320 that operates as a database server may be capable of providing an interface for interacting with one or more data stores (such as, for example, a data store 340 described below). Where appropriate, the server 320 may include one or more servers 320; be unitary or distributed; span multiple locations; span multiple machines; span multiple datacenters; or reside in a cloud, which may include one or more cloud components in one or more networks.

In particular embodiments, the one or more links 350 may couple the server 320 to one or more data stores 340. The data store 340 may store any suitable information, and the contents of the data store 340 may be organized in any suitable manner. As an example and not by way or limitation, the contents of the data store 340 may be stored as a dimensional, flat, hierarchical, network, object-oriented, relational, XML, NoSQL, Hadoop, or other suitable database or a combination or two or more of these. The data store 340 (or the server 320 coupled to it) may include a database-management system or other hardware or software for managing the contents of the data store 340. The database-management system may perform read and write operations, delete or erase data, perform data deduplication, query or search the contents of the data store 340, or provide other access to the data store 340.

In particular embodiments, the one or more servers 320 may each include one or more search engines 322. The search engine 322 may include hardware, software, or both for providing the functionality of the search engine 322. As an example and not by way of limitation, the search engine 322 may implement one or more search algorithms to identify network resources in response to search queries received at the search engine 322, one or more ranking algorithms to rank identified network resources, or one or more summarization algorithms to summarize identified network resources. In particular embodiments, a ranking algorithm implemented by the search engine 322 may use a machine-learned ranking formula, which the ranking algorithm may obtain automatically from a set of training data constructed from pairs of search queries and selected Uniform Resource Locators (URLs), where appropriate.

In particular embodiments, the one or more servers 320 may each include one or more data monitors/collectors 324. The data monitor/collection 324 may include hardware, software, or both for providing the functionality of the data collector/collector 324. As an example and not by way of limitation, the data monitor/collector 324 at the server 320 may monitor and collect network-traffic data at the server 320 and store the network-traffic data in the one or more data stores 340. In particular embodiments, the server 320 or another device may extract pairs of search queries and selected URLs from the network-traffic data, where appropriate.

This disclosure contemplates any suitable clients 330. The client 330 may enable a user at the client 330 to access or otherwise communicate with the network 310, the servers 320, or other clients 330. As an example and not by way of limitation, the client 330 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. The client 330 may be an electronic device including hardware, software, or both for providing the functionality of the client 330. As an example and not by way of limitation, the client 330 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, the client 330 may include one or more clients 330; be unitary or distributed; span multiple locations; span multiple machines; span multiple datacenters; or reside in a cloud, which may include one or more cloud components in one or more networks.

For a decade at least, scientists and major technology companies (Palantir, Google, Microsoft) have tried to use computer science algorithms only to find, categorize, and analyze statutes and similar legal material, without success. In contrast, the method 100 and system use legal researchers as SMEs to create unique ontologies for topic areas that sufficiently narrow and define the target for the machine. This approach succeeds where universal ontologies applicable to all statutes or regulations have failed. The method 100 and system provide a generalizable approach to teaching the machine to properly capture what the law states, so to provide data for more ambitious uses of AI in rules-based expert systems. The method 100 and system are designed to significantly reduce the cost of multi-jurisdictional comparative legal research, and to foster new uses of legal information through its transformation into coded data.

The method 100 and system focus on articulating a standard, scientific approach to defining the scope of a data set, collecting the law, creating and implementing a robust coding scheme, controlling quality, and maintaining transparency and reproducibility. Elements of the process maintain transparency and replicability, and are very important discriminators from existing chat bots and large language models. Using existing chat bots which leverage AI, it is possible to ask an AI machine to retrieve and describe the law on various topics, but there is no transparency to allow a user to assess accuracy. Embodiments of the disclosed system use AI, but keep the process transparent. Additionally, embodiments of the disclosed system render findings as numeric data, which is required for research use, while chat bots return only text. The method 100 and system are iterative, and focused on measuring the apparent characteristics of legal texts, rather than interpreting their legal meaning. Whether the term “cell phone” in a traffic law (for example) would cover a wi-fi-enabled iPad being used for a Skype call could be quite important for a lawyer applying that law to a particular case, but for purposes of creating legal data, it would normally suffice in the initial coding to observe that the term “cell phone” is used to specify the device whose use the law regulates.

The method 100 and system can be used to identify observable features in any sort of text—for example, identifying product features given pdf product manuals, identifying video descriptions given video transcripts, etc. The AI assistant correctly identifies a subset of data on any topic, as well as fill in features within that subset of data via the set of features coded in the software (e.g. MonQcle). The method 100 and system can be used to identify product features for an e-commerce store, animal traits for an encyclopedic dataset, software traits for a review site, or as in the example highlighted above, legal features for jurisdictional law topics. The specifically configured user interfaces and database, described above, allow a SME to interact with and notify an AI training service which constantly updates a model.

The system and related method 100 can meet the need for comparative data in the legal information market. Once a domain of law is coded, it never needs to be done again, only updated. Therefore, once the sales models are right and the corpus sufficiently large, the comparative element of legal research, now repeated daily by law firms and researchers, will be transformed into a purchasable legal information product. The availability of accurate and up-to-date machine-readable legal data at a scaled price will enable an unforeseeable range of uses; consider the analogy of the effect of machine-readable data on the weather forecasting business. Immediate applications of the system and related method 100 include (1) providing data to power compliance tools with fair housing, class action, and other laws; (2) powering legal services marketing tools for websites like Justia; and (3) new products providing plain-language information about the law to consumers (see, e.g., CPHLR's periodic opioid law updates created for Quest Diagnostics).

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure. All patent applications, patents, and publications cited herein are incorporated by reference in their entirety.

### REFERENCES

The following publications are incorporated herein by reference in their entirety:
I. Chalkidis & D. Kampas, “Deep learning in law: early adaptation and legal word embeddings trained on large corpora,” Artificial Intelligence and Law 27, 171-98 (2019).
S. Burris, “Public Health Law Monitoring and Evaluation in a Big Data Future,” I/S: A Journal of Law & Policy for the Information Society, 11(1), 115-26 (2015).
W. Knight, “Why Tesla Is Designing Chips to Train Its Self-Driving Tech,” Wired (Sep. 7, 2021) (available at https://www.wired.com/story/why-tesla-designing-chips-train-self-driving-tech/)

What is claimed:

1. A method for textual identification and feature generation, the method comprising:
providing a corpus of texts;
defining a scope including type, time, and geographic dimensions of the texts to be analyzed;
selecting a subset of the corpus of texts based on the defined scope;
collecting, identifying, and manually coding using a coding protocol selected features of the subset of texts using a pre-defined research procedure and feature set;
creating a corpus of machine-readable data and metadata in a software database from the coded features of the subset of texts;
training an AI assist tool to code the selected features of the subset of texts, using the manually coded features and the subset of texts; and
using the trained AI assist tool to apply the coding protocol to create new and update existing data and metadata in the software database.

2. The method of claim 1, wherein the manual coding step comprises the steps of:
providing the coding protocol and the subset of texts to a plurality of individuals;
receiving coded features from the plurality of individuals;
comparing the coded features to one another; and
providing the coded features to the software database where two or more of the plurality of individuals agree with one another.

3. The method of claim 2, further comprising the step of calculating a divergence rate from the comparison of the coded features, and decreasing an overlap in an amount of the provided subset of texts when the divergence rate is below a threshold.

4. The method of claim 1, wherein the corpus of texts comprises statutes and judgments.

5. The method of claim 1, further comprising the step of tagging one or more texts in the corpus of texts with a time stamp.

6. The method of claim 1, further comprising the step of periodically evaluating an accuracy of the trained AI assist tool by comparing the created and updated data and metadata to data created by an individual.

7. The method of claim 1, further comprising publishing a subset of the data and metadata in the software database to a public website.

8. A method for the systematic collection, analysis, and dissemination of laws and policies across jurisdictions or institutions, and over time, the method comprising:
defining a project scope;
conducting background research;
developing coding questions;
collecting a corpus of law and creating a corpus of legal text;
coding the corpus of legal text with a trained artificial intelligence (AI) algorithm, using the coding questions;
publishing and disseminating coded corpus of legal text to a software database; and
tracking and updating the coded corpus of legal text in the software database.

9. The method of claim 8, wherein the step of defining the project scope comprises selecting a type, time window, and geographic range of the corpus of law.

10. The method of claim 8, wherein the step of collecting the corpus of law comprises using a scraping tool to search and retrieve legal text from the Internet.

11. The method of claim 8, wherein the step of coding the corpus of legal text comprises the steps of:
obtaining a prediction job command to a publish/subscribe topic;
coding the corpus of legal text with a prediction worker function;
storing a prediction result to a cloud storage; and
publishing a prediction process finished event to the publish/subscribe topic.

12. The method of claim 8, wherein the step of tracking and updating the coded corpus of legal text in the software database comprises the steps of:
periodically checking at least one external database of legal text for updates; and
coding the updates to the corpus of legal text with the trained artificial intelligence (AI) algorithm, using the coding questions.

13. The method of claim 8, wherein the corpus of law comprises statutes and ordinances.

14. A system for collection and analysis of legal text, comprising a non-transitory computer-readable storage medium with instructions stored thereon, which when executed by a processor, perform steps comprising:
accepting a project scope from a user;
querying a corpus of legal text using the project scope to obtain a subset of legal text;
obtaining a set of coding questions;
coding the subset of legal text using the coding questions; and
storing the coded subset of legal text in a software database.

15. The system of claim 14, wherein the steps further comprise:
periodically checking at least one external database of legal text for updates to the corpus of legal text; and
coding the updates to the corpus of legal text using the coding questions.

16. The system of claim 14, the steps further comprising coding the subset of legal text with a trained artificial intelligence (AI) algorithm.

17. The system of claim 16, wherein the steps further comprise:
accepting a set of manually-coded legal text;
comparing the manually-coded legal text to corresponding legal text coded by the trained AI algorithm; and
training the AI algorithm with manually coded legal text which differs from the legal text coded by the AI algorithm.

18. The system of claim 14, wherein the project scope comprises a type, time window, and geographic range of the corpus of legal text.

19. The system of claim 14, further comprising a cloud storage communicatively connected to the processor via a network, comprising the software database.

20. The system of claim 14, wherein the steps further comprise identifying common terms of art in the corpus of legal text and generating keywords based on the identified common terms of art.
